(19) United States
(12) Patent Application Publication
(10) Pub. No.: US 2011/0203751 A1
(43) Pub. Date: Aug. 25, 2011

(54) PROTECTIVE SCREEN APPARATUS FOR AUTOMOTIVE VEHICLE

(75) Inventor: Jim Ray Marentes Aguilar, Albuquerque, NM (US)

(73) Assignee: Mesa Digital, LLC.

(21) Appl. No.: 12/975,995

(22) Filed: Dec. 22, 2010

Related U.S. Application Data
(60) Provisional application No. 61/308,175, filed on Feb. 25, 2010.

(51) Int. Cl. B60J 11/06

(52) U.S. Cl. 160/368.1

(57) ABSTRACT

A protective screen apparatus for attachment to a front grille of an automotive vehicle to prevent insects and other debris from entering interior elements associated with the vehicle. The apparatus includes a removable frame surrounding a fine mesh material in order to form a protective screen that can be attached with respect to the front grille of the vehicle. The protective screen can be interchangeably located in a discrete area behind the front grille in order to protect the interior elements associated with the front region of the vehicle. The protective screen can be easily removed, cleaned, and inserted back into the front grille. Such a protective screen apparatus can cover the front grille of the automotive vehicle in a simple and efficient manner.

### CROSS-REFERENCE TO PROVISIONAL APPLICATION

This nonprovisional patent application claims the benefit under 35 U.S.C. §119(e) of U.S. Provisional Patent Application Ser. No. 61/308,175 filed on Feb. 25, 2010, entitled “Protective Screen Apparatus for Automotive Vehicle,” which is hereby incorporated by reference in its entirety.

### TECHNICAL FIELD

Embodiments are generally related to protective devices and methods for protecting interior parts of a vehicle. Embodiments are also related to a protective screen apparatus for attachment to a front grille of an automotive vehicle.

### BACKGROUND OF THE INVENTION

Automotive vehicles generally include an air intake grille at a front end that permits air into an engine compartment in order to absorb heat from a radiator associated with an engine cooling system. Insects and other debris can enter the front grille region thereby inferring with the operation of the radiator and damage the vehicle. The insect bodies and debris can possibly disrupt air flow through the radiator and result in a condition of overheating that may mar and wear the internal engine of the vehicle.

The majority of prior art approaches have been employed to protect the interior parts of the vehicle. For example, U.S. Pat. No. 6,830,119 entitled “Net for covering front grille of automotive,” which issued to Troy Whitworth on Dec. 14, 2004 and is incorporated herein by reference, describes a method and an apparatus for protecting an automobile from damage from insects or other debris entering a front grille of the automobile. The apparatus of U.S. Pat. No. 6,830,119 includes a net, which can be attached to the automobile so that the net covers a substantial portion of the front grille of the automobile. The net can also be attached at its first end underneath a hood of the automobile and at its second end to a front license plate of the automobile. Such a device further includes a first cord, which may pass through a first sleeve of the net, and a second cord, which may pass through a second sleeve of the net.

One of the problems with such device is that the net is difficult and time consuming to install. Another problem is that the net is unsightly due to the fact that it covers a substantial portion of the outside of the automobile grille. Additionally, the cords that connect to the license plate can be easily entangled and damaged by the elements during, for example, a storm or excessive heat and thus may come loose during movement of the vehicle and actually damage the car or parts of the car.

Based on the foregoing, it is believed that a need exists for an improved protective screen apparatus and method for preventing insects and other debris from entering interior elements of an automotive vehicle. A need also exists for a removable protective screen associated with a fine mesh material, as described in greater detailed herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved protective screen apparatus and method.

It is another aspect of the disclosed embodiments to provide for an improved removable protective screen associated with a fine mesh material for attachment to a front grille of the automotive vehicle.

The aforementioned aspects and other objectives and advantages can now be achieved as described herein. A protective screen apparatus for attachment to a front grille of an automotive vehicle to prevent insects and other debris from entering interior elements associated with the vehicle is disclosed herein. The apparatus includes a removable frame surrounding a fine mesh material in order to form a protective screen that can be attached with respect to the front grille of the vehicle. The protective screen can be interchangeably located in a discrete area behind the front grille in order to protect the interior elements (e.g. an engine, a transmission cooler, a condenser, one or more fluid lines, etc.) associated with the front region of the vehicle. The protective screen can be easily removed, cleaned, and inserted back into the front grille. Such a protective screen apparatus can cover the front grille of the automotive vehicle in a simple and efficient manner.

The protective screen apparatus can be interchangeably located in a discrete area behind an upper front grille of the vehicle to cover the radiator and a lower front grille to cover the condenser, cooler, and fluid lines. The mesh of the protective apparatus includes a number of wires bounded in order to form openings that is permeable to air flow. The protective screen permits an unobstructed passage to let air enter and/or leave the interior elements associated with the front region of the vehicle. The protective screen subsequently protects the interior elements from being messed up by insects splattered on a fast moving automotive vehicle. The mesh can be a fine material of a predetermined shape that suitably fits the discrete area behind the grille of the automotive vehicle. The protective screen disclosed herein can be designed to specifically fit any of several models of automobiles and can be readily available to the vehicle manufacture to quickly incorporate them into a vehicle according to a specific customer requirement.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a protective screen apparatus attached to a front grille of an automotive vehicle, in accordance with the disclosed embodiments;

FIG. 2 illustrates a perspective view of a protective screen apparatus attached to an upper front grille and a lower front grille of an automotive vehicle, in accordance with the disclosed embodiments;

FIG. 3 illustrates an exploded view of the protective screen apparatus, in accordance with the disclosed embodiments; and

FIG. 4 illustrates an exploded view of the protective screen apparatus attached to the front grille of the automotive vehicle, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

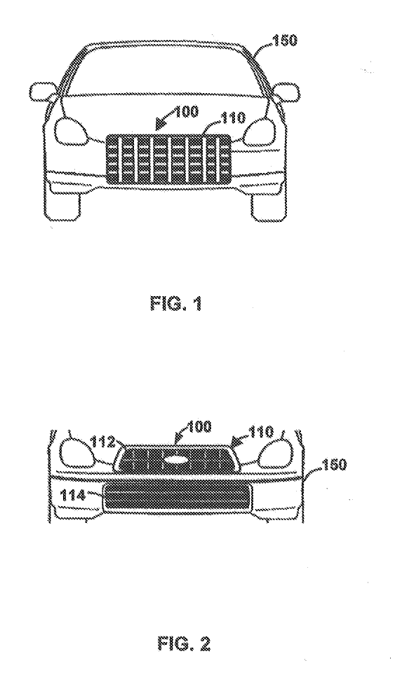

FIG. 1 illustrates a perspective view of a protective screen apparatus 100 attached to a front grille 110 of an automotive vehicle 150, in accordance with the disclosed embodiments. Note that in FIGS. 1-4, identical or similar blocks are generally indicated by identical reference numerals. The protective screen apparatus 100 can be coupled to the front grille 110 associated with the vehicle 150. The apparatus 100 can be readily adapted for use on a vehicle such as, for example, trucks, trailers, buses, motorized recreational vehicles, recreational trailers, cube vans, vans, mini-vans, sports cars, sedans, and the like. The term vehicle employed hereinafter is intended to cover all forms of vehicles, including those referenced above.

The apparatus 100 can be employed to prevent insect and other debris (e.g. bug, soot, dirt gravels, etc.) from entering the vehicle 150 via the front grille 110. The apparatus 100 permits an unobstructed passage to let air enter and/or leave the interior elements associated with the front region of the vehicle 150. The protective screen 100 subsequently protects the interior elements from being messed up by insects splattered on the fast moving automotive vehicle 150.

FIG. 2 illustrates a perspective view of the protective screen apparatus 100 attached to an upper front grille 112 and a lower front grille 114 of an automotive vehicle 150, in accordance with the disclosed embodiments. The front grille 110 of the vehicle 150 possibly includes the upper front grille 112 that covers the radiator and the lower front grille 114 that covers the condenser, cooler, and fluid lines at the front region of the vehicle 150. The protective cover apparatus 100 can be interchangeably located in a discrete area behind the upper front grille 112 of the vehicle 150 to cover the radiator and the lower front grille 114 to cover the condenser, cooler, and fluid lines. The protective screen apparatus 100 in association with the front grille 112 and 114 can permit air to pass through the front region of the vehicle and thereby protects the interior elements such as, for example, engine, radiator, transmission cooler, condenser, one or more fluid lines, etc., associated with the front region of the vehicle.

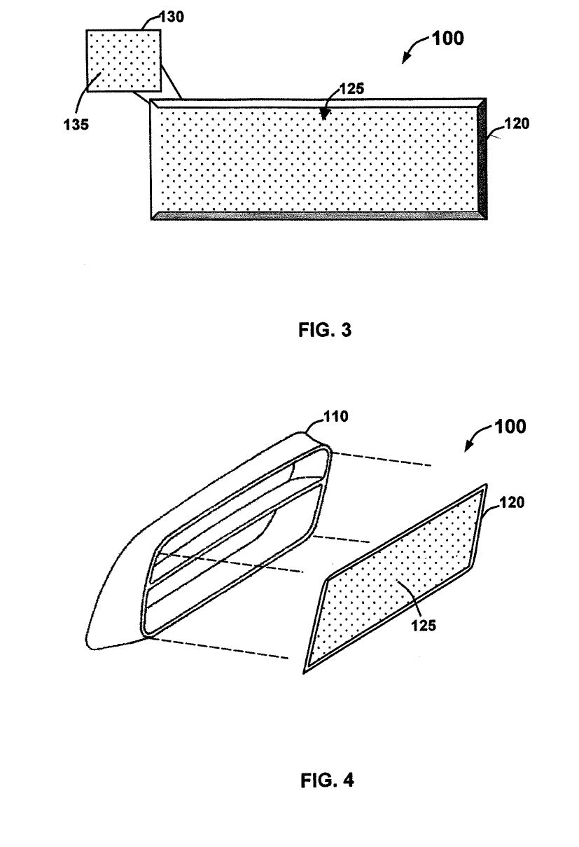

FIG. 3 illustrates an exploded view of the protective screen apparatus 100, in accordance with the disclosed embodiments. The protective screen apparatus 100 generally includes a removable frame 120 surrounding a fine mesh material 125 in order to form a protective screen that can be attached with respect to the front grille 110 of the vehicle 150. The frame 120 peripherally surrounds and supports the mesh 125 which may be made of any suitable material and the mesh is effective to prevent small insects blown against the screening from passing through.

The mesh 125 generally includes a number of wires 130 bounded to form openings 135 that can be employed to provide an unobstructed passage to let air enter and/or leave the vehicle 150. The mesh material 125 efficiently prevents damage caused by the insects and other debris striking the front region of the vehicle 150 in motion. The mesh 125 comprises a fine material of a predetermined shape that suitably fits the discrete area behind the grille 110 of the automotive vehicle 150. The mesh 125 can be configured from a material such as, for example, metal, plastic, synthetic or natural substances, depending upon design considerations. It can be appreciated that other types of materials may be utilized in place of the suggested material. However, it will be desirable that the material selected be capable of withstanding temperatures and other weather elements common to areas in which the invention is to be employed.

The removable frame 120 associated with the fine mesh material 125 can be formed in a generally planar configuration and positioned parallel behind the plane of the grille 110 associated with the vehicle 150. The protective screen apparatus 100 substantially covers all the slots associated with the grille 110. The openings 135 in the mesh material 125 is small enough so that a typical insect, such as a mosquito, cannot pass through the openings 135 and thus cannot enter the grille 110 or enter the vehicle 150 through the grille 110. The actual structure of the protective screen apparatus 100 may be simple and easily assembled with respect to different types of vehicles.

Note that the embodiments discussed herein generally relate to the protective screen apparatus which can include variations in size, material, shape, and form, depending upon design considerations. The shape and size of the protective screen apparatus are described for purposes of clarity and specificity; however, they should not be interpreted in any limiting way. However, it will be apparent to those skilled in the art that other size, material, shape, and form can be employed as desired without departing from the scope of the invention.

FIG. 4 illustrates an exploded view of the protective screen apparatus 100 attached to the front grille 110 of the automotive vehicle 150, in accordance with the disclosed embodiments. The protective screen 100 can be interchangeably located in a discrete area behind the front grille 110 in order to protect the interior elements such as, for example, an engine, a transmission cooler, a condenser, one or more fluid lines, etc., associated with the front region of the vehicle 150. The interior of the mesh 125 protects the grille 110 of the vehicle 150 from obstructions such as brush, shrubs, and other debris. The mesh 125 also allows air flow to permit cooling of the vehicle engine and elevate air resistance.

The protective screen 100 can be easily removed, cleaned, and inserted back into the front grille 110. It is contemplated that the particulate matter can be removed from the protective screen 100 by vigorously shaking the protective screen 100 or directing a fluid, such as water or air, against the protective screen 100. Once the protective screen 10 has been cleaned, it may simply be repositioned behind the front grille 110. Such a protective screen apparatus 100 can cover front grille 110 of the automotive vehicle 150 in a simple and efficient manner. The protective screen apparatus 100 disclosed herein can be designed to specifically fit any of the several models of automobiles and can be readily available to the vehicle manufacture to quickly incorporate them into a vehicle according to a specific customer requirement.

Based on the foregoing, it can be appreciated that in some embodiments, a protective screen apparatus can include a mesh material permeable to air flow, and a frame surrounding the mesh material to form a protective screen supported by the frame, wherein the frame associated with the protective screen is interchangeably located in a discrete area behind a front grille of a vehicle in order to protect interior elements associated with a front region of the vehicle.

Additionally, in other embodiments, the disclosed protective screen can be interchangeably located in a discrete area behind an upper front grille of the front grille of the vehicle. In still other embodiments, the disclosed protective screen can be interchangeably located in a discrete area behind a lower front grille of the front grille of the vehicle. In yet other embodiments, the disclosed protective screen can be configured to be removed, cleaned, and inserted back into the front grille. Additionally, in other embodiments, the disclosed mesh material can be configured from a fine material to permit air to enter and leave the vehicle. In still further embodiments, the disclosed protective screen can be configured to prevent insects and other debris from entering an interior of the vehicle. In still other embodiments, the protective screen associated with the front grille protects at least a radiator of the vehicle, a transmission cooler of the vehicle, a condenser of the vehicle, and/or at least one fluid line of the vehicle.

In still another embodiment, the disclosed protective screen apparatus can include a mesh material permeable to air flow and a frame surrounding the mesh material to form a protective screen supported by the frame, wherein the frame associated with the protective screen is interchangeably located in a discrete area behind a front grille of a vehicle in order to protect interior elements associated with a front region of the vehicle, wherein the protective screen is interchangeably located in a discrete area behind an upper front grille of the front grille of the vehicle. In such an embodiment, the protective screen can be configured to be removed, cleaned, and inserted back into the front grille. Additionally, in such an embodiment the mesh material can constitute a fine material to permit air to enter and leave the vehicle. The protective screen can also be configured to prevent insects and other debris from entering an interior of the vehicle.

In still another embodiment, the disclosed protective screen apparatus can include a mesh material permeable to air flow and a frame surrounding the mesh material to form a protective screen supported by the frame, wherein the frame associated with the protective screen is interchangeably located in a discrete area behind a front grille of a vehicle in order to protect interior elements associated with a front region of the vehicle, wherein the protective screen is interchangeably located in a discrete area behind a lower front grille of the front grille of the vehicle.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A protective screen apparatus, comprising:
a mesh material permeable to air flow; and
a frame surrounding said mesh material to form a protective screen supported by said frame, wherein said frame associated with said protective screen is interchangeably located in a discrete area behind a front grille of a vehicle in order to protect interior elements associated with a front region of said vehicle.

2. The apparatus of claim 1 wherein said protective screen is interchangeably located in a discrete area behind an upper front grille of said front grille of said vehicle.

3. The apparatus of claim 1 wherein said protective screen is interchangeably located in a discrete area behind a lower front grille of said front grille of said vehicle.

4. The apparatus of claim 1 wherein said protective screen is configured to be removed, cleaned, and inserted back into said front grille.

5. The apparatus of claim 1 wherein said mesh material comprises a fine material to permit air to enter and leave said vehicle.

6. The apparatus of claim 1 wherein said protective screen prevents insects and other debris from entering an interior of said vehicle.

7. The apparatus of claim 1 wherein said protective screen associated with said front grille protects a radiator of said vehicle.

8. The apparatus of claim 1 wherein said protective screen associated with said front grille protects a transmission cooler of said vehicle.

9. The apparatus of claim 1 wherein said protective screen associated with said front grille protects a condenser of said vehicle.

10. The apparatus of claim 1 wherein said protective screen associated with said front grille protects at least one fluid line of said vehicle.

11. The apparatus of claim 1 wherein said protective screen associated with said front grille protects at least one of the following interior elements of said vehicle:
a radiator;
a transmission cooler;
a condenser; and
at least one fluid line.

12. A protective screen apparatus, comprising:
a mesh material permeable to air flow; and
a frame surrounding said mesh material to form a protective screen supported by said frame, wherein said frame associated with said protective screen is interchangeably located in a discrete area behind a front grille of a vehicle in order to protect interior elements associated with a front region of said vehicle, wherein said protective screen is interchangeably located in a discrete area behind an upper front grille of said front grille of said vehicle.

13. The apparatus of claim 12 wherein said protective screen is configured to be removed, cleaned, and inserted back into said front grille.

14. The apparatus of claim 12 wherein said mesh material comprises a fine material to permit air to enter and leave said vehicle.

15. The apparatus of claim 12 wherein said protective screen prevents insects and other debris from entering an interior of said vehicle.

16. A protective screen apparatus, comprising:
a mesh material permeable to air flow; and
a frame surrounding said mesh material to form a protective screen supported by said frame, wherein said frame associated with said protective screen is interchangeably located in a discrete area behind a front grille of a vehicle in order to protect interior elements associated with a front region of said vehicle, wherein said protective screen is interchangeably located in a discrete area behind a lower front grille of said front grille of said vehicle.

17. The apparatus of claim 16 wherein said protective screen is configured to be removed, cleaned, and inserted back into said front grille.

18. The apparatus of claim 16 wherein said mesh material comprises a fine material to permit air to enter and leave said vehicle.

19. The apparatus of claim 16 wherein said protective screen prevents insects and other debris from entering an interior of said vehicle.

20. The apparatus of claim 16 wherein said protective screen associated with said front grille protects at least one fluid line of said vehicle.
